(19) United States
(12) Patent Application Publication
(10) Pub. No.: US 2024/0280158 A1
(43) Pub. Date: Aug. 22, 2024

(54) Devices, Systems, and Methods for Shock Absorption

(71) Applicants: Savior Brain Inc., Arlington, VA (US); The Board of Trustees of the Leland Stanford Junior University, Stanford, CA (US)

(72) Inventors: David Benjamin Camarillo, Stanford, CA (US); Daniel James Faulkner, Portland, OR (US); Nicholas James Cecchi, Anaheim, CA (US); Jeffrey Allison, Lake Oswego, OR (US)

(21) Appl. No.: 18/569,097

(22) PCT Filed: Jun. 14, 2022
(86) PCT No.: PCT/US2022/033497

§ 371 Date: Dec. 11, 2023

Related U.S. Application Data
(60) Provisional application No. 63/210,230, filed on Jun. 14, 2021.

(51) Int. Cl. F16F 9/04; A42B 3/12

(52) U.S. Cl. CPC F16F 9/04; A42B 3/12

(57) ABSTRACT

A shock absorbing device is disclosed comprising a first collapsible chamber having a first reservoir space, a first wall configured to receive an impact force, and a first orifice configured to eject a fluid from the first reservoir space in reaction to the impact force; and a second collapsible chamber having a second reservoir space, a second wall configured to receive at least a portion of the impact force, a second orifice in communication with the first orifice and the second reservoir space, and at least one ejection orifice in communication with the second reservoir space and configured to eject the fluid from the second reservoir space in reaction to the said received at least a portion of the impact force.

### CROSS-REFERENCE TO RELATED APPLICATION(S)

This application claims priority to U.S. Provisional Patent Application No. 63/210,230, filed Jun. 14, 2021, which is incorporated herein by reference in its entirety.

### STATEMENT AS TO RIGHTS TO INVENTIONS MADE UNDER FEDERALLY SPONSORED RESEARCH OR DEVELOPMENT

This invention was made with government support under FAIN R43NS119134, Grant Number 1R43NS119134-01 awarded by the National Institutes of Health. The government has certain rights in the invention.

### BACKGROUND

Mitigation of damage to biological tissues and inanimate objects as a result of physical impact is a complex technical challenge. Beyond absorption of physical forces acting on an impacted object, control of loading rate and energy dissipation are important to protecting the object from damage. Existing collapsible shock absorption systems do not have ideal force profiles under impact loading. For example, the force exerted by foams and existing personal protective equipment (PPEs) increases greatly as the material of the system is displaced under loading. In many cases, such as that of solid foam padding, the entire thickness of the collapsible energy absorber cannot be used to absorb or dissipate energy due to compaction of the material. These systems are thus engineered for performance under high impact loading, leaving the systems too stiff to optimally absorb energy at lower force levels experienced during low severity impacts.

Additionally, hydraulic shock absorption mechanisms used in other industries typically have a rigid design, necessitating a great deal of space. For example, rigid hydraulic shock absorption devices are more than double the size of their working stroke length. The space requirements of traditional rigid shock absorption devices can prohibit these devices from being deployed effectively in many space-constrained applications, such as equipment and systems that are small or portable such as protective helmets, or that have configurations that do not allow incorporation of additional shock absorption equipment.

Hydraulic shock absorbers such as those used in car suspension use incompressible liquid flowing through orifices that reduces in effective size with increased displacement to provide a nearly optimal minimum force. However, the hardware in car suspension can be too large for many other shock absorbing applications. For example, helmets have shock absorbers but do not have space for metal pistons and cylinders like those car suspension. Therefore, helmets and other shock absorbing applications such as shipping/packing often use foams or air bags to absorb energy, which can be packaged in much more constrained spaces. However, foams cannot scale their force commensurate with impact velocities and thereby may apply too low of a force during initially small displacement, then too high of a force as they undergo larger displacement and compaction of voids in the foam. Air bags can include an orifice to allow for flow so the bag can avoid the foam compaction issue and fully deflate. However, the compressibility of gas leads to significant low-force displacement after the initiation of impact and, therefore, suffers the same too low then too high force trade-off, should the bag fully deflate before the impact velocity reaches zero. Thus, there exists a need for improved shock absorption devices and systems.

### SUMMARY

The present disclosure generally relates to devices, systems, and methods for reducing the force experienced by an object and/or modulating the time over which the force is experienced by the object. In some cases, the present disclosure relates to devices, systems, and methods for reducing injury to a biological tissue (e.g., the skull, brain, hip bone, hip tissue, one or more components of the shoulder (e.g., ligaments, tendons, bone, or other connective tissue), tibia, fibula, or other body part of a subject wearing impact protection equipment). Not necessarily all such aspects or advantages are achieved by any particular embodiment. Thus, various embodiments may be realized in a manner that achieves or optimizes one or more advantages or group of advantages taught herein without necessarily achieving other aspects or advantages as may also be taught or suggested herein. Presented herein are devices for personal protective equipment.

According to some aspects of the disclosure, a shock absorbing device comprises a first collapsible chamber having a first reservoir space, a first wall configured to receive an impact force, and a first orifice configured to eject a fluid from the first reservoir space in reaction to the impact force. The shock absorbing device also comprises a second collapsible chamber having a second reservoir space, a second wall configured to receive at least a portion of the impact force, a second orifice in communication with the first orifice and the second reservoir space, and at least one ejection orifice in communication with the second reservoir space and configured to eject the fluid from the second reservoir space in reaction to said received a portion of the impact force.

In some embodiments, at least one set of the first collapsible chamber and the second collapsible chamber may be secured to an inner shell of a helmet. For example, the at least one set of the first collapsible chamber and the second collapsible chamber can be secured to a padding on the inner shell of the helmet. In some instances, the first collapsible chamber and the second collapsible chamber may be secured to a skullcap that is configured to be housed within an inner shell of a helmet.

In some embodiments, the shock absorbing device may further include at least one interfacing collapsible chamber between the first collapsible chamber and the second collapsible chamber. The first collapsible chamber and the second collapsible chamber may be substantially non-distensible. The at least one ejection orifice may further include a sacrificial diaphragm that is configured to open at a predetermined pressure. The first collapsible chamber and second collapsible chamber may be enclosed within a surrounding enclosure. The first orifice, second orifice, and at least one ejection orifice may be variably sized and/or shaped to create an approximately constant reaction force to the impact force.

In some embodiments, at least one of the first collapsible chamber and the second collapsible chamber may further include a second ejection orifice that is configured to eject the fluid from at least one of the first reservoir space or second reservoir space in reaction to the impact force. In some cases, the ejection orifice and second ejection orifice may be oriented at an angle ranging from about 0 degree to about 180 degrees relative to each other.

In some embodiments, the shock absorbing device may further comprise a distensible container attached to the at least one ejection orifice and configured to act as a reservoir to expand and contain fluid during application of the impact force and return the fluid back to recharge the reservoir spaces when the impact force is removed. The distensible container may include an elastic reservoir configured to maintain a constant back-pressure after an initial inflation. The fluid may be incompressible. In some instances, the second collapsible chamber may comprise a plurality of ejection orifices. In some instances, the first collapsible chamber may comprise at least one other orifice besides the first orifice.

According to other aspects of the disclosure, a shock absorbing device comprises a first collapsible chamber having a first reservoir space, a first wall configured to receive an impact force, and at least one first ejection orifice configured to eject a first incompressible fluid from the reservoir space in reaction to the impact force. The shock absorbing device also comprises a second collapsible chamber having a second reservoir space, a second wall configured to receive at least a portion of the impact force, and a second ejection orifice configured to eject a second incompressible fluid from the second reservoir space in reaction to said received portion of the impact force. The first collapsible chamber and the second collapsible chamber have an orientation such that said portion of the impact force received by the second wall of the second collapsible chamber is substantially parallel to a direction of the impact force received by the first wall of the first collapsible chamber.

In some embodiments, the shock absorbing device may further include at least one interfacing chamber between the first collapsible chamber and the second collapsible chamber, the interfacing collapsible chamber including a first interfacing wall configured to receive at least a portion of the impact force, and a third ejection orifice configured to eject a third incompressible fluid from the interfacing reservoir space in reaction to the at least a portion of the impact force.

In some embodiments, the shock absorbing device may further comprise a distensible container attached to the ejection orifice and configured to act as a reservoir to expand and contain fluid during application of the impact force and return the fluid back to recharge the reservoir spaces when the impact force is removed. Each of the at least one first ejection orifice and the second ejection orifice may include a sacrificial diaphragm that is configured to open at a predetermined pressure.

According to some further aspects of the disclosure, a shock absorbing device comprises a collapsible chamber having a reservoir space enclosed by a first impermeable layer configured to contain a fluid within the reservoir space, a second non-distensible layer surrounding the first layer and configured to receive an impact force, and at least one ejection orifice configured to eject a fluid from the reservoir space in reaction to the impact force.

In some embodiments, the at least one ejection orifice may include a sacrificial diaphragm that is configured to open at a predetermined pressure. In some instances, the shock absorbing device may further comprise at least one distensible container attached to the at least one ejection orifice and configured to act as a reservoir to expand and contain fluid during application of the impact force and return the fluid back to recharge the reservoir spaces when the impact force is removed.

### BRIEF DESCRIPTION OF THE DRAWINGS

The novel features of the present disclosure are set forth with particularity in the appended claims. A better understanding of the features and advantages of the present disclosure will be obtained by reference to the following detailed description that sets forth illustrative embodiments, and the accompanying drawings of which:

FIG. 1A shows a stack of shock bags having an intra-bag orifice and a single common external orifice according to an example;

FIG. 1B shows a cross-section of a stack of shock bags with their intra-bag orifices in communication with each other and the common external orifice according to an example;

FIG. 2A shows a stack of shock bags each including an independent external orifice;

FIG. 2B shows a cross-section of the stack of shock bags having independent external orifices shown in FIG. 2A;

FIG. 3 shows a stack of shock bags with each orifice having a different size;

FIGS. 4A-4B show external orifices of an uncollapsed stack of bags connected to uninflated or under-inflated distensible containers, whereby an impact force collapses the stack of bags and extends the distensible containers according to an example;

FIGS. 5A-5B show a system comprising sacrificial diaphragm(s) that can be broken at pre-specified pressure to allow outflow for single impact energy absorption, in accordance with embodiments;

FIGS. 6A and 6B show a head form before and after impact on a stack of shock bags connected to distensible containers according to an example;

FIG. 7 shows multiple sets of shock bags assembled and superimposed according to an example;

FIG. 8 shows a system of shock bags distributed and affixed an exterior of a skull cap according to an example;

FIG. 9A shows a system of shock bags distributed and affixed inside a helmet shell according to an example;

FIG. 9B shows a system of shock bags distributed and affixed on top of energy absorbing foam affixed to the helmet shell according to an example;

FIG. 9C shows the system of shock bags distributed and affixed inside a helmet shell of FIG. 9A-9B donned to create a comfort fit according to an example;

FIG. 10A shows a Helmet Performance Score (HPS) for Riddell™ SpeedFlex Diamond helmet as compared to an untuned helmet including the shock bag system (Savior) of the present disclosure as shown in FIG. 9C according to an example;

FIG. 10B shows a graph of cumulative Head Acceleration Response Metric (HARM) values after a full battery of impact tests for a stock helmet and the same helmet with comfort padding replaced with single shock bag, as well as a graph of HARM values at the Side Upper impact location at two impact velocities according to an example;

FIGS. 11A-C shows a distensible container including an elastic reservoir configured to maintain a constant back-pressure after initial inflation even as it receives more fluid and expands according to an example;

FIG. 12 shows a set of shock bags contained within a surrounding enclosure to contain any liquid escaping a shock bag or distensible container according to an example;

FIG. 13 shows a shock bag or system of connected shock bags contained within a surrounding enclosure configured to contain any liquid escaping a shock bag, distensible container or one of its associated reservoirs according to an example;

FIGS. 14A-E show an illustration of how axial stress is reduced by adding convolutions and reducing a shock bag's radius of curvature;

FIGS. 15A-B are illustrations of an embodiment of the shock bag with two distinct layers surrounding an internally contained liquid according to an example;

FIG. 16 an illustration of a cross-section of a serial stack of two shock bags undergoing an impact according to an example;

FIG. 17A shows an embodiment where a set of two serial liquid shock bag absorbers have their orifices connecting to shared distensible containers according to an example;

FIG. 17B shows an embodiment in which each shock bag of a serial liquid shock bag absorber includes two external orifices, where the two external orifices are connected to the same distensible container according to an example;

FIG. 17C shows an embodiment in which each external orifice of a shock bag connects to a shared distensible container according to an example;

FIGS. 18A-18B show graphs displaying force efficiency and energy absorption ratio results after impact testing of the serial liquid shock bag absorber and seven existing American football helmet shock absorbing technologies; and

FIG. 19 displays examples of force vs. time curves of three impact scenarios.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The present disclosure generally relates to devices, systems, and methods for reducing the force experienced by an object and/or modulating the time over which the force is experienced by the object. In some cases, the present disclosure relates to devices, systems, and methods for reducing injury to a biological tissue such as the skull and/or brain, the hip, shoulder, shins, or other body parts of a subject wearing a helmet. Not necessarily all such aspects or advantages are achieved by any particular embodiment. Thus, various embodiments may be realized in a manner that achieves or optimizes one or more advantages or groups of advantages taught herein without necessarily achieving other aspects or advantages as may also be taught or suggested herein.

Among the most important shortcomings of current technologies using gas (e.g. air, CO2) and/or solid (e.g. foam, elastomeric lattice) shock absorbers are that they weakly adapt their resistive force to varying impact velocity and the nonlinear force-displacement properties of the material (e.g., a significant increase in resistance to force is observed when foam absorbers have been compressed to or close to their maximum compression volume, which can result in increased—potentially damaging—forces on the object (or body part) being protected with the absorber).

An absorber comprising a liquid can transmit a lower overall impact force that adapts to the incoming impact velocity. Examples of liquids include an incompressible liquid or substantially incompressible liquid, such as water, oil, or others.

In some implementations, an incompressible liquid can fill a shock bag made from a non-stretchable or a non-distensible or substantially non-distensible bag or a bag comprising one or more non-distensible or substantially non-distensible materials. This will allow for a quick, efficient rise in the force against one or more surfaces of the shock bag at initiation of impact. In some implementations, the shock bag may be comprised of two distinct materials: a first, interior impermeable material that holds the liquid and a second, exterior non-distensible material that surrounds the first, interior impermeable material.

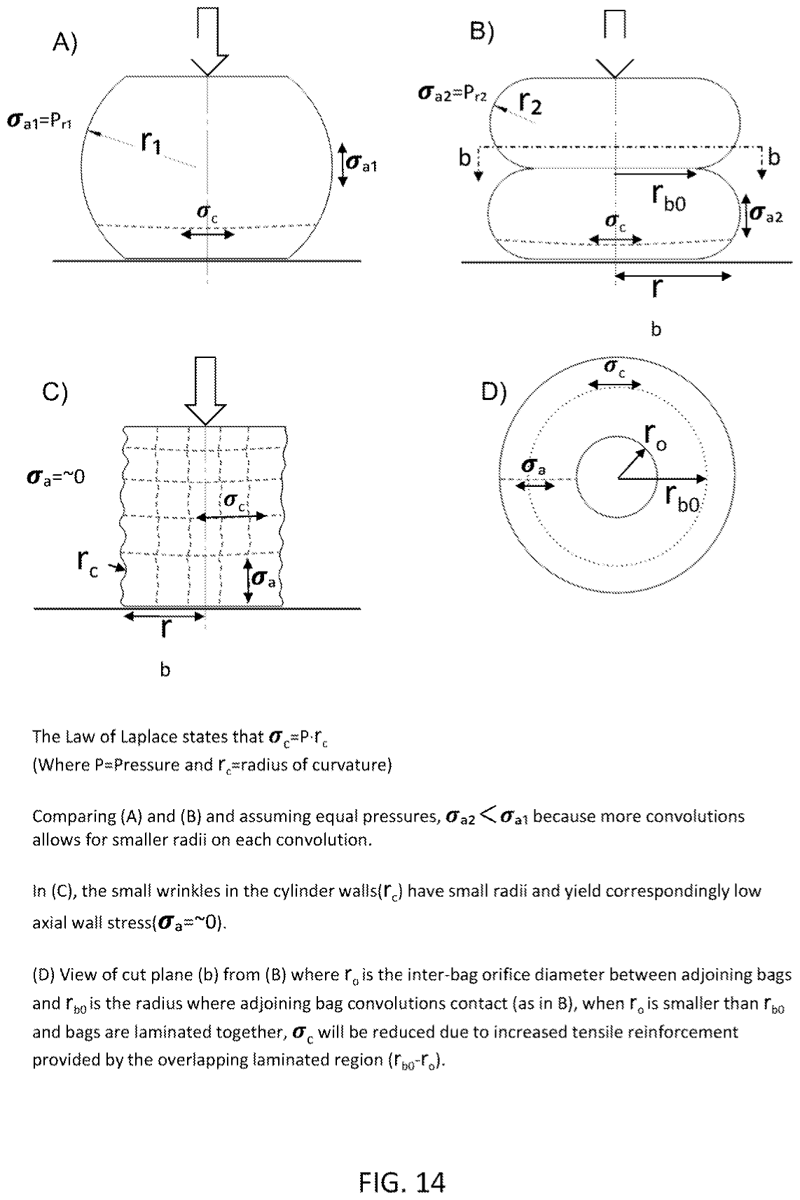

In some cases, an incompressible liquid contained within a non-distensible or substantially non-distensible bag can transmit force to its surroundings more efficiently than a gas or foam. In some cases, less liquid can be used in an absorber to achieve a similar or equal weight to force capacity ratio than if gas or a foam were used. In some cases, decreasing the volume of absorber material (e.g., by using liquid instead of gas or foam) can also decrease the surface area on which the force of the liquid (e.g., when pressurized during impact to the absorber) acts, which can cause increased force applied per square centimeter on (e.g., an interior surface of) the container (e.g., the non-distensible bag), for example in a direction perpendicular to the force (e.g., increased circumferential hoop stress in the wall of the container) and/or in a longitudinal direction (for example, stress in fibers running between the contact plates). (See FIG. 14 showing an illustration of how axial stress is reduced by adding convolutions and reducing a shock bag's radius of curvature). For example, in a 5 cm thick football helmet, liquid can only cover ˜⅓ of the surface area of the head for equal weight compared to some foams. With this small surface area for distributing forces, professional football impacts, for example, can require ˜500 psi (pounds per square inch) liquid pressure or more (e.g., from 100 psi to 500 psi, from 200 psi to 500 psi, from 300 psi to 500 psi, from 400 psi to 500 psi, or more than 500 psi). This pressure will require a circumferential hoop stress in the wall of the bag. In the longitudinal direction, however, the wall stress in the bag can be reduced by providing more convolutions with increasingly smaller radii of curvature.

In some cases, the bag can undergo wall stress that increases as a function of the radius of curvature of the bag. In some cases, this increase in stress and/or pressure can lead to distension or failure of a portion (e.g., a wall) of the container (e.g., the non-distensible bag).

Strategies for minimizing wall stress in an absorber comprising a liquid in a bag include reducing the radius of curvature of the absorber container by adding more bags (i.e. convolutions) and increasing the total amount of material. An example of minimizing wall stress in an absorber includes using filled bags occupying the same or a similar volume as an alternative single-bag system where each of the plurality of bags is smaller in volume when filled with liquid than the bag of an alternative single-bag system, but the total volume is the same. The additional aggregate surface area of the plurality of smaller bags may be sufficient to bear the high pressures exerted on the walls.

An example of increasing the total amount of material such as measured by total cross-sectional thickness of material can include increasing a wall surface area on which the liquid is exerting force but the cross-sectional thickness of the wall, which may or may not have an equal thickness over the entirety of one, more than one, or all of the bags, distributes the force and decreases the ratio of stress to cross-sectional wall thickness at a given point. Examples of a cross-sectional thickness include but are not limited to 0.1 mm to 1.5 mm and examples of internal volumes include but are not limited to 2 mL to 150 mL.

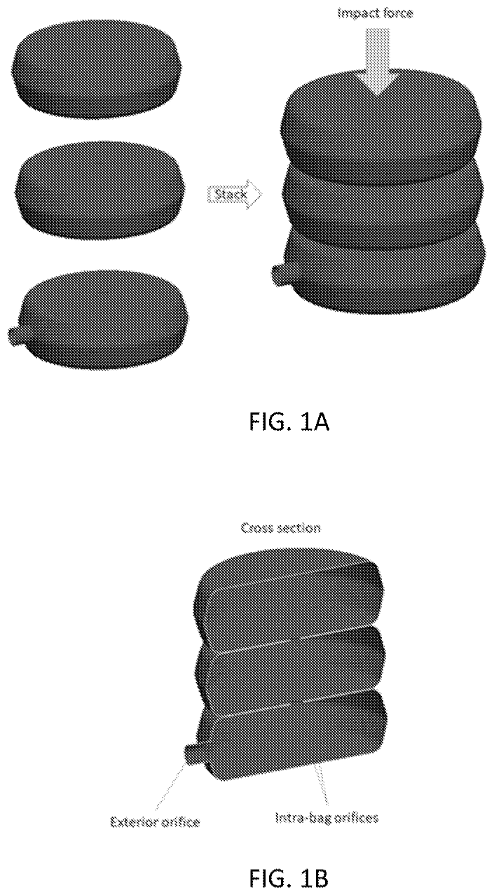

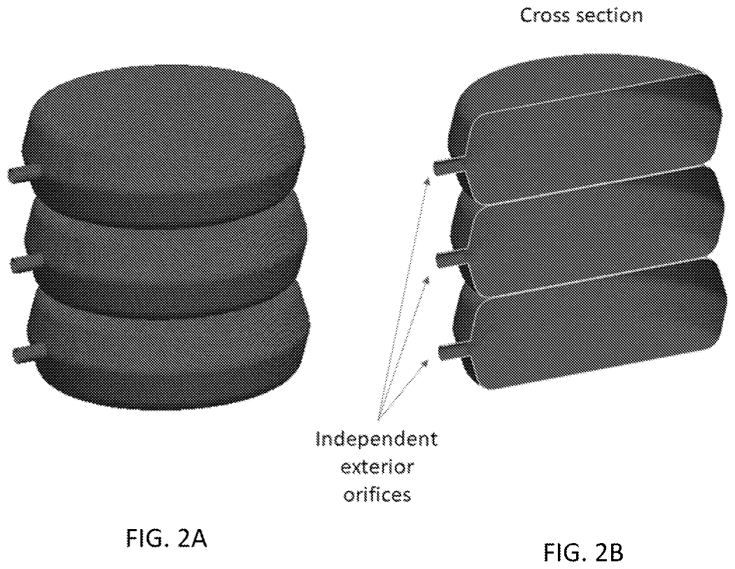

These two technical features can be realized in a system independently or in combination and can allow for conventional materials to construct thin-walled bags that can deflate to a small fraction of the inflated size and match the weight of foam/solid and air/gas based devices. In an aspect, each bag can be partially-deflated or filled with liquid but not fully extended. In some cases, an absorber can comprise one or more containers such as substantially non-distensible bags. In some cases, an absorber can comprise a plurality of containers such as shown in FIG. 1B, FIG. 2A, and FIG. 2B.

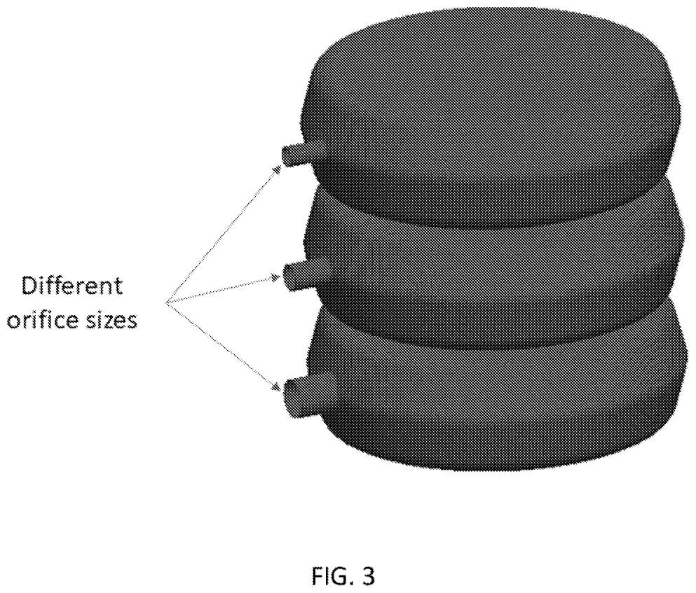

In some cases, one or more bags of an absorber device or system can comprise one or more orifices (e.g., in a wall of the one or more bags), for instance, as shown in FIG. 1B, FIG. 2A, and FIG. 3. Flow through an orifice can have a back pressure which can increase with velocity, thereby allowing a shock bag to appropriately adapt its force to an incoming ballistic velocity such that it precisely deflates. In an aspect, each orifice is partially or entirely comprised of a rigid material to maintain the shape and size of the orifice throughout duration of an impact and/or regular use.

Flow from the liquid bag can be accomplished by inclusion of one or more orifice(s). In some cases, a first bag of the plurality of bags can be in fluid communication with one or more second bags of the plurality of bags of the device or system (e.g., via an orifice in a shared internal wall of the first and second bag, for instance as shown in FIG. 1B). In some cases, a first bag of the plurality of bags may not be in fluid communication with one or more second bags of the plurality of bags of the device or system (e.g., by a non-liquid-permeable wall of the first and/or second bag or shared wall, e.g., as shown in FIG. 2B).

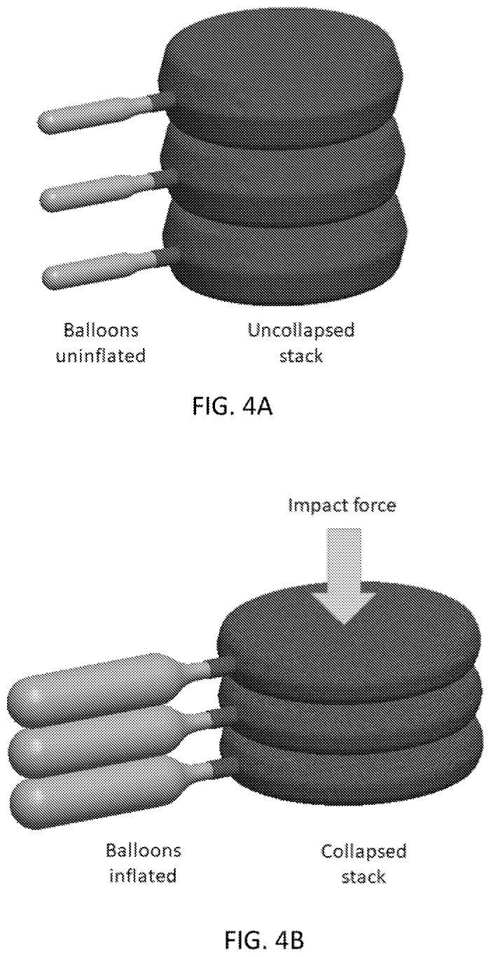

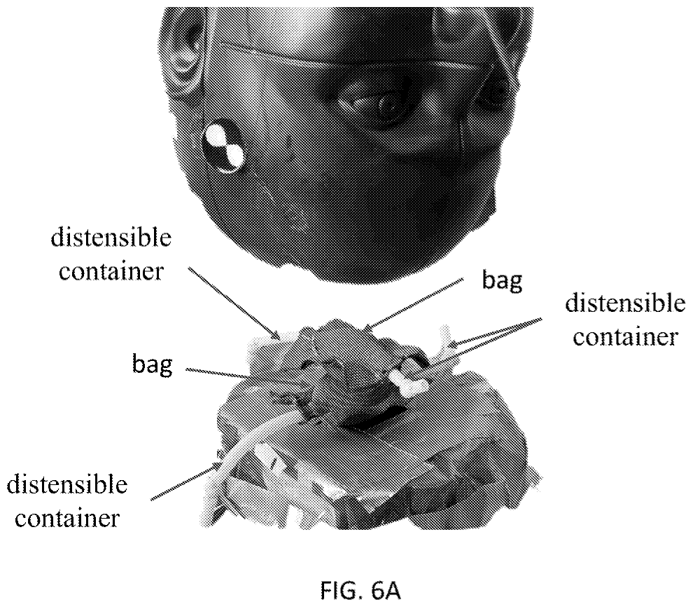

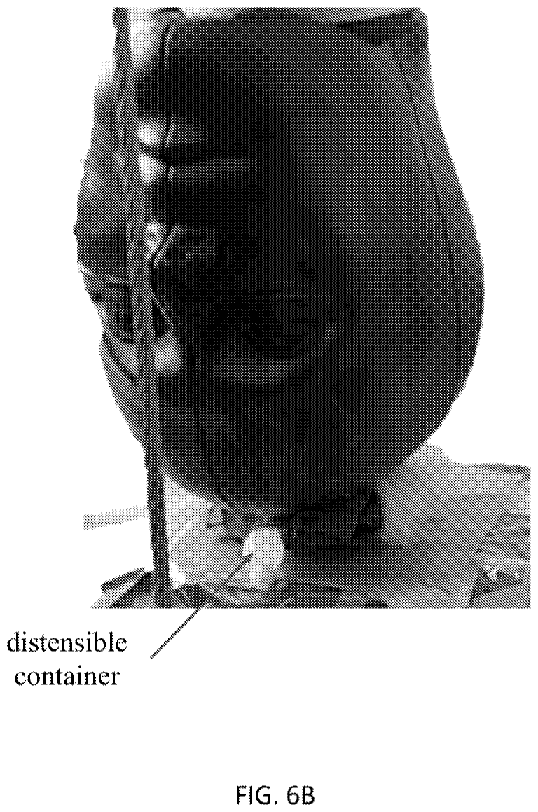

The orifices may be oriented symmetrically around the bag, such as one or more on each half, one or more on each side, or in a circular fashion around the perimeter of a circular bag, or asymmetrically. Further, the orientation of the orifices of each bag may be identical or offset relative to one another. Example of identical orientation is shown in FIG. 4A where all orifices are on top of one another. An example of offset orientation can be seen in FIG. 6A, where two orifices are facing perpendicular to each other.

In some implementations, orifices may have different diameters configured to tune the force response so that as an impacting mass decelerates, bags with larger orifices deflate first then bags with smaller orifices can continue to apply a constant external pressure/force at lower velocities. Turning to FIG. 3, a stack of partially deflated bags each orifice having a different size are shown according to an example. In an aspect, a bottom bag would deflate first under impact, then middle bag, then bottom bag to give approximately constant force in decelerating a ballistic mass. The device of claim 1, wherein the at least a portion of the impact force received by the second collapsible chamber is in a substantially parallel direction as received by the first wall of the first collapsible chamber. In an aspect, the reservoir space of a first collapsible chamber is in bidirectional fluidic communication with the ejection orifice of the second collapsible chamber. In an example, a second embodiment, there are intra-bag orifices of variable diameter and commonly shared external orifice(s) to vent the flow out of the system (FIGS. 1A-1B). This second embodiment allows for fewer total but larger orifices.

In some cases, employing multiple effective orifice sizes in a system or device (e.g., using a larger orifice diameter for an orifice in a wall of a second bag of the system or device than the diameter of an orifice in a wall of a first bag of the system or device (for example, as shown in FIG. 3), whether in a case where the first and second bags are in fluid communication e.g., by one or more internal orifice(s), or where the first and second bags are fluidically isolated from one another) or increasing contact area with displacement, an approximately constant minimum dissipating force can be achieved. Therefore, liquid is an ideal medium to absorb energy if it can be appropriately packaged with weight and volume requirements.

Turning to FIGS. 4A-4B, in some implementations, each shock bag orifice can be coupled to a distensible container configured to serve as a reservoir to expand and contain fluid during application of external pressure and return fluid back to recharge each bag when the external pressure is removed. In some implementations, the distensible container can be configured to pressurize the bag. In an example, the distensible containers can be initially minimally inflated to provide only enough back pressure to keep non-stretchable bags under tension.

The shock bags can be made from non-stretchable materials such that deformation of the bag exerts substantial pressure release towards its orifice and coupled distensible container coupled to one or more external orifices of the bag, device or system. In some cases, a distensible container can be elastic or stretchable such as a balloon. The distensible container can be made from a number of suitable materials including a balloon made from latex and hose made from a rubber type of material. In some cases, the distensible container can be made of a non-elastic or stretchable material that is folded and expands when pressure is exerted. In an example, the distensible container is a rubber hose configured to inflate at <20 psi and to receive all of the fluid from the shock bag when it becomes fully inflated. In an aspect, the inflation pressure of the distensible container is selected to be less than the comfort limit for a particular part of the body. In one embodiment, a piece of foam may be added to the interior or exterior of the shock bag's outermost fabric material such that it provides the user with additional comfort.

For example, in a helmet the non-stretchable bags may not be under tension until the helmet is donned on a head which will flatten the top bag and maintain a comfortable pressure based on the back pressure of the distensible containers. During impact, the distensible containers inflate and develop more pressure that will eventually return fluid back to non-stretchable bags after external force is removed. As shown in FIGS. 4A-4B, external orifices of an uncollapsed stack of bags are connected to uninflated or under-inflated distensible containers, whereby an impact force collapses the stack of bags and inflates the distensible containers according to an example.

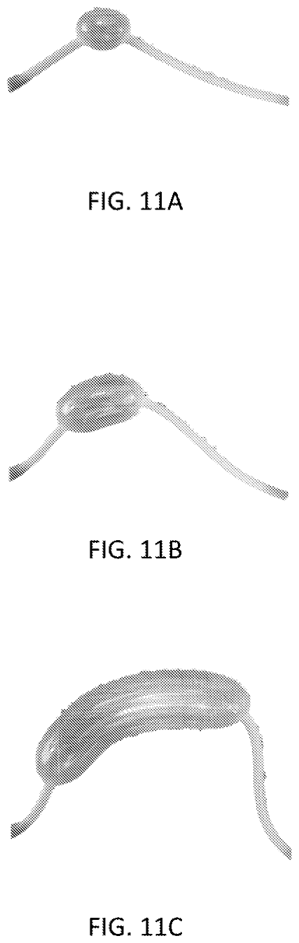

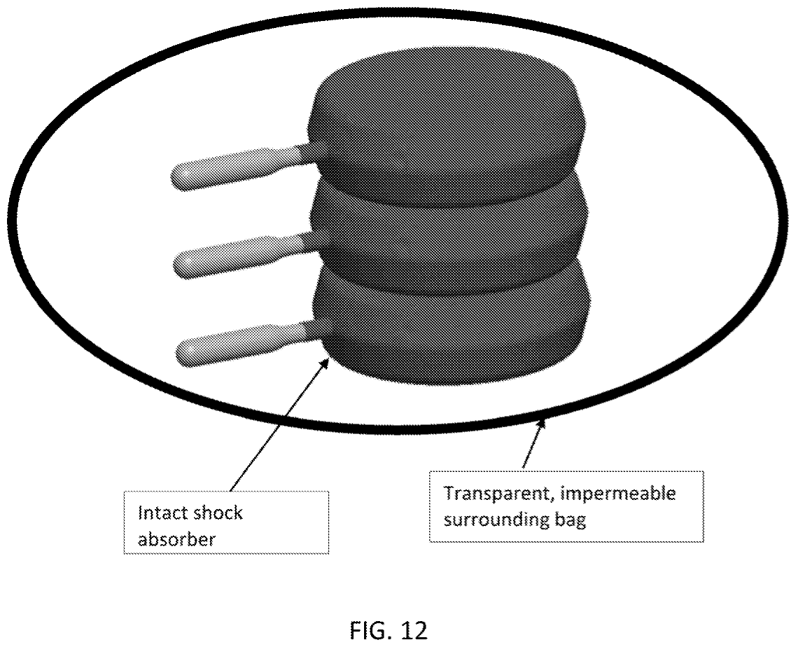

In some cases, the serial liquid airbags are intended for repeat shock absorbing. In this embodiment, a distensible container (e.g., an elastic external distensible container), for example, as shown in FIGS. 4A, 4B, 11A, 11B, and 11C can be coupled to the one or more orifices (e.g., one or more exterior orifices) of the device or system, for example, to (a) maintain a pre-pressurization, and/or (b) to aid in return the liquid back to non-stretchable bags after the impact is complete.

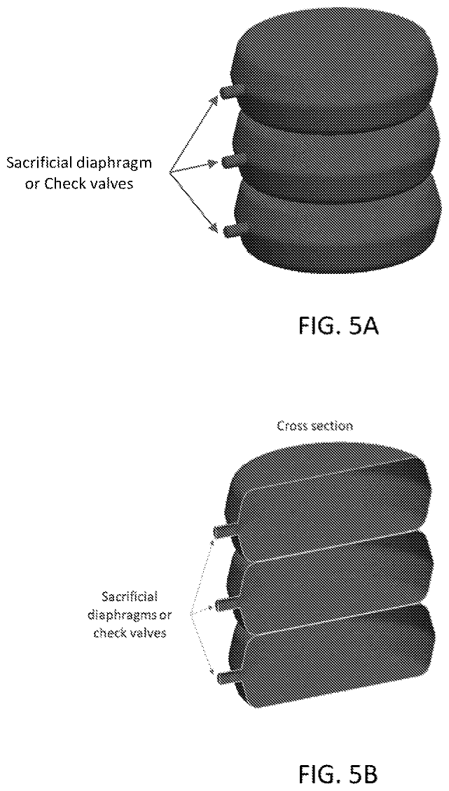

In some embodiments, only single impact energy dissipation is necessary and one or more of the orifices can be coupled instead to a sacrificial membrane (e.g., as shown in FIG. 5A and FIG. 5B) or a check valve or other known devices that allows for flow to initiate only after a predetermined pressure has been reached. This sacrificial membrane or diaphragm may be constructed via a plug, a bonded or welded seal over the face of the orifice, or a bonded or welded sealing of a temporarily collapsed orifice. In an aspect, this temporary seal will be impermeable to the contained fluid until such time as the required internal pressure reaches the threshold needed to burst the sacrificial membrane or diaphragm.

Turning to FIGS. 6A and 6B, a head form is shown before and after impact on a stack of bags connected to a set of distensible containers. During impact, distensible containers are filled with liquid. In an aspect, depending on the configuration of the number and orientation of bags, the rate of filling of each distensible container can be varied.

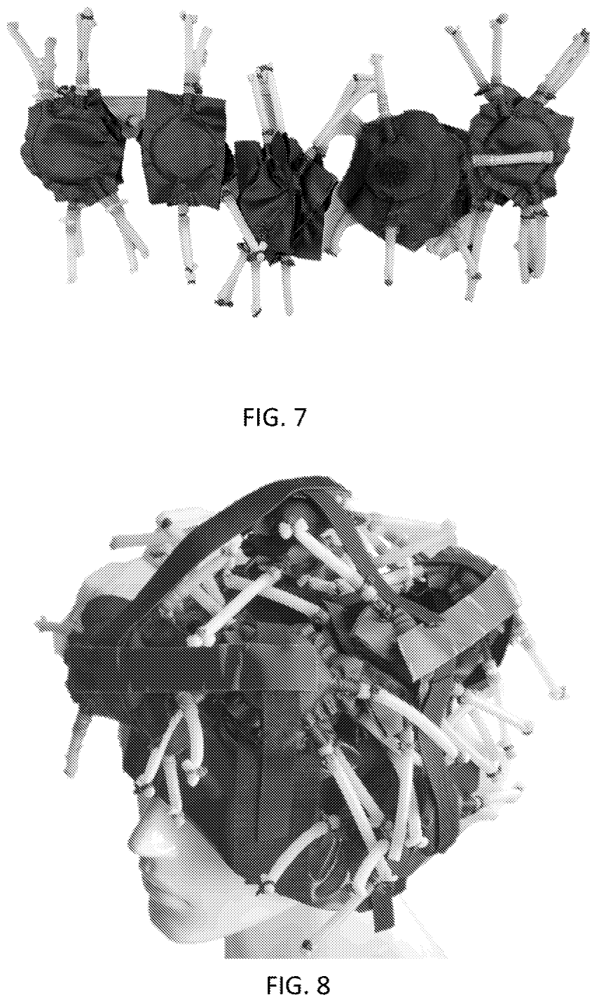

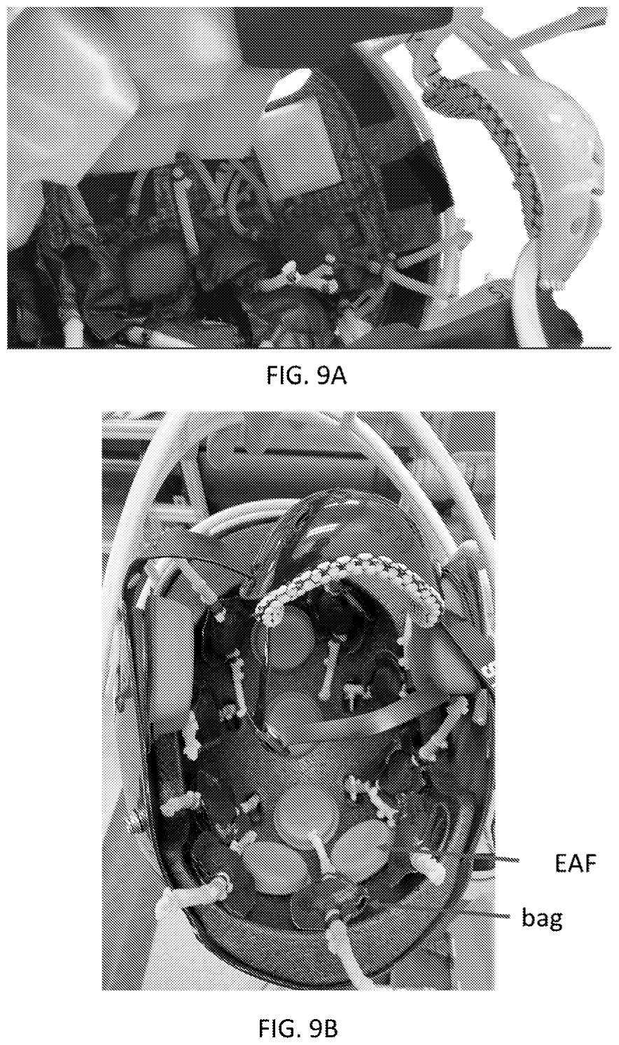

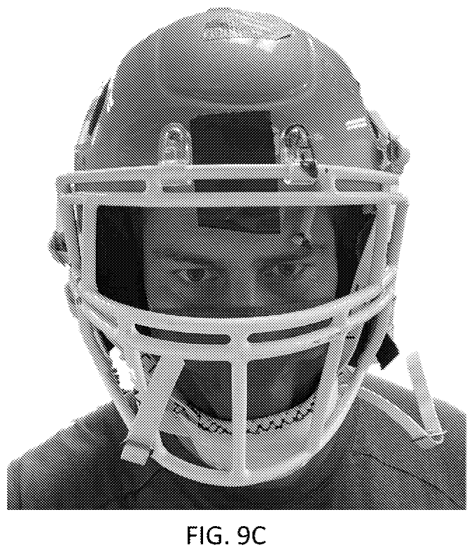

Turning to FIGS. 7 and 8, a system of shock bags can be assembled, superimposed, distributed, and affixed to the exterior of a skull cap according to an example. The skull cap can be adapted to fit within a helmet. Alternatively, as shown in FIGS. 9A-9C, a system of shock bags can be distributed and affixed directly inside a helmet shell according to an example. The helmet including the shock system can be adjusted to create a comfort fit. The shock bags can be slightly pressurized, for example, to <10 psi. In some embodiments, a system of shock bags can be distributed and affixed directly to a helmet shell or shell padding (FIG. 9A). In some embodiments, a system of shock bags can be distributed and affixed on top of energy absorbing foam (EAF) which is affixed to the helmet shell or shell padding (FIG. 9B). In an aspect, the shock bags affixed to the inner surface of a helmet's energy absorbing foam replaces comfort padding and can serve as a secondary layer of impact protection while also providing comfort.

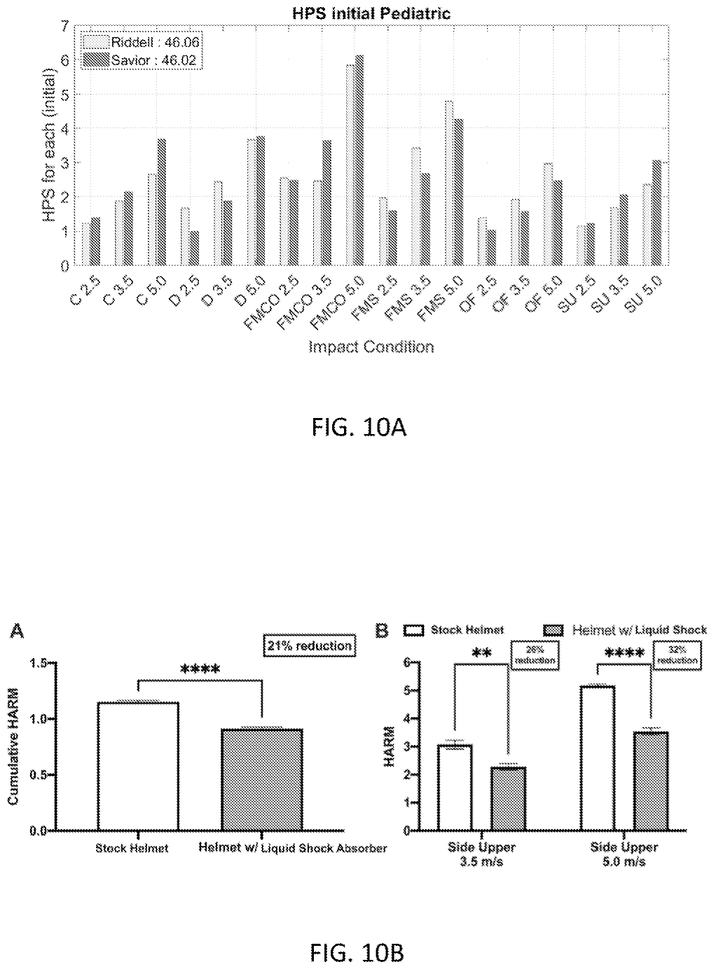

Empirical results demonstrate performance of the shock bag system. Turning to FIG. 10A, a graph showing a Helmet Performance Score (HPS) for Riddell™ SpeedFlex Diamond helmet (Rosemont, IL) as compared to a helmet including the shock bag system (Savior) of the present disclosure as shown in FIG. 9C. A lower score is indicative of better performance where SU is a side upper helmet location, OF is oblique front, FMS is facemask side, FMCO is facemask center oblique, C is side and D is oblique rear. FIG. 10B at A shows a cumulative Head Acceleration Response Metric (HARM) value after a full battery of impact tests for a stock helmet and the same helmet with individual comfort pads replaced with single stack shock bags. Lower score indicates better performance. Results show that replacing comfort pads in the stock helmet with single stack shock bags results in a 21% improvement in performance. FIG. 10B at B shows HARM values at the Side Upper impact location at two impact velocities. The Side Upper location is deemed particularly dangerous for yielding diagnosed concussions. Results show that replacing comfort pads in the stock helmet with single stack shock bags results in a 26% and 32% improvement in performance at 3.5 m/s and 5.0 m/s impact velocities, respectively.

In an aspect, the distensible container can include an elastic reservoir to maintain constant back-pressure after an initial inflation even as it receives more fluid and expands. As shown in FIGS. 11A-11C, this back pressure can be selected for the comfort of the non-stretchable bag, which will also maintain the same pressure.

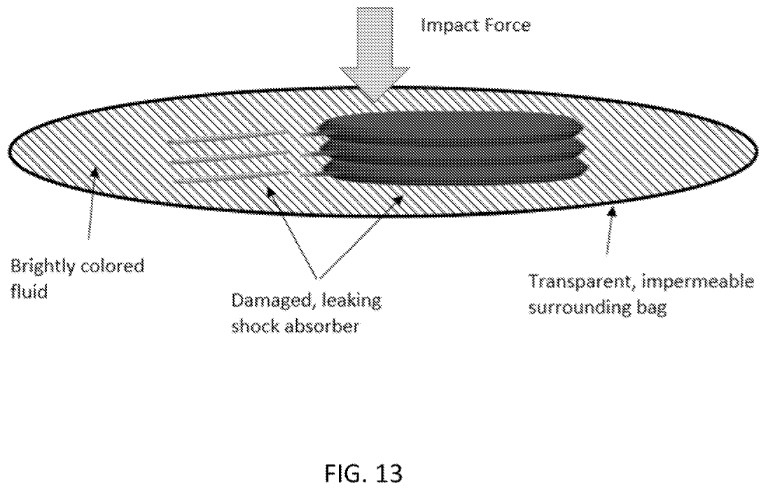

A liquid-filled shock bag may burst and leak the fluid that it contains after sustaining an impact or other damaging exposure. It may be undesirable for a user of the shock bag to make contact with the contained fluid, for safety, cosmetic, or comfort reasons. It may also be beneficial to have a mechanism of containing leaked fluid and/or permanently viewing it after leaking, as an indicator that the shock bag, or any item that utilizes one or more of the shock bags needs maintenance or needs to be discarded. In some implementations, each shock bag or system of connected shock bags can be contained within a surrounding enclosure to contain any liquid escaping the shock bag or distensible container or one of its associated reservoirs as shown in FIGS. 12 and 13. In the case of a shock bag, bursting or leaking internally contained fluid, whether intentionally by design, or by damage via bursting, tearing, or piercing of fabric, the leaking fluid, may be contained by the surrounding enclosure. In an example, the surrounding enclosure can be an impermeable wrapper or plastic and may be comprised of a soft, high-strength, stretchable, impermeable material, such that it can compress and conform upon impact without breaking or leaking fluid. In addition, the surrounding enclosure can be transparent, such that viewing whether the shock bag has leaked any fluid is possible without soiling the helmet.

In an aspect, the surrounding enclosure may be sufficiently large or larger than the shock bag, such that it can fully contain all of the fluid that leaks out of the shock bag and remain at low internal pressure, so that it will not also burst. For example, in the case of a helmet featuring a system of liquid filled shock bags, the surrounding enclosure may take the shape of part or all of the inside surface of the helmet. The liquid may be of a bright or fluorescent color, such that it would be easy for a user to see if fluid had leaked into the surrounding enclosure.

FIGS. 14A-E is an illustration of how axial stress is reduced by adding convolutions and reducing a shock bag's radius of curvature. FIG. 14A shows a shock bag having the smallest curvature and lowest wall stress/stretch. FIG. 14B shows a shock bag having the largest curvature and greatest stress/stretch. FIG. 14C shows a shock bag having two convolutions and therefore smaller radius and smaller wall stress/stretch than the shock bag in FIG. 14B. As the shock bag in FIGS. 14B and 14C compress, they have an increase in contact area which can compensate for reducing pressure during deceleration to maintain constant force. FIGS. 14D and 14E show how allowing a material membrane between convolutions circumferentially relieves stress. Reduced axial and circumferential stresses allows for less stretch of the bag and, therefore, less distension/stretch. Material stretch reduces the rate of increase of the force which leads to less efficient shock absorber and higher overall impact forces.

Another method for increasing the number of convolutions is to create a bellows-style construction. In an example, bellow can include multiple discs of material which are alternately adhered, bonded, attached, or affixed at the outer radius of one disc and subsequently at the inner radius of the next disc in a serial stack or two or more. In an example, A stack could be capped by a contiguous cap at the top and bottom of the serial stack. One or more orifices may be present in the sidewall of the bellows-style construction of the serial stack.

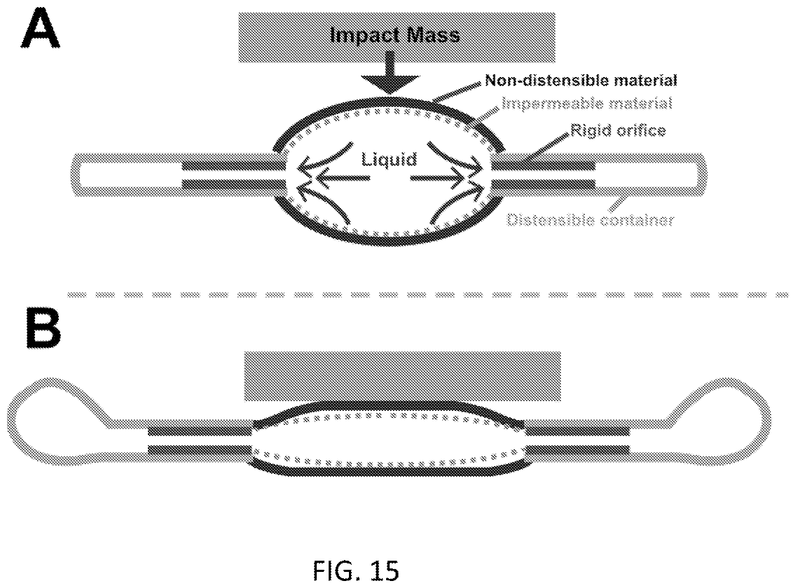

FIGS. 15A-B are illustrations of an embodiment of the shock bag with two distinct layers surrounding an internally contained liquid. The first layer is an interior, impermeable material that directly contains the liquid and the second layer is an exterior, non-distensible material that surrounds the first interior, impermeable layer. Examples of impermeable materials include but are not limited to nylon, Mylar, polyurethane, vinyl, silicone, polypropylene, or natural and synthetic rubbers. Examples of non-distensible materials include but are not limited to ripstop, Dyneema, and nylon. In other embodiments, two layers may be integrated into a single layer, including but not limited to polyurethane coated nylon, reinforced vinyl fabric, polyvinyl chloride, or vinyl coated polyester. Upon impact, the shock bag is compressed and the contained fluid is pressed out through an orifice and into a distensible container. In one embodiment, the orifice may be made of a sufficiently rigid material such that its dimensions remain fixed during the entire impact process. After impact, the distensible container contracts, therefore returning the liquid back to the original shock bag.

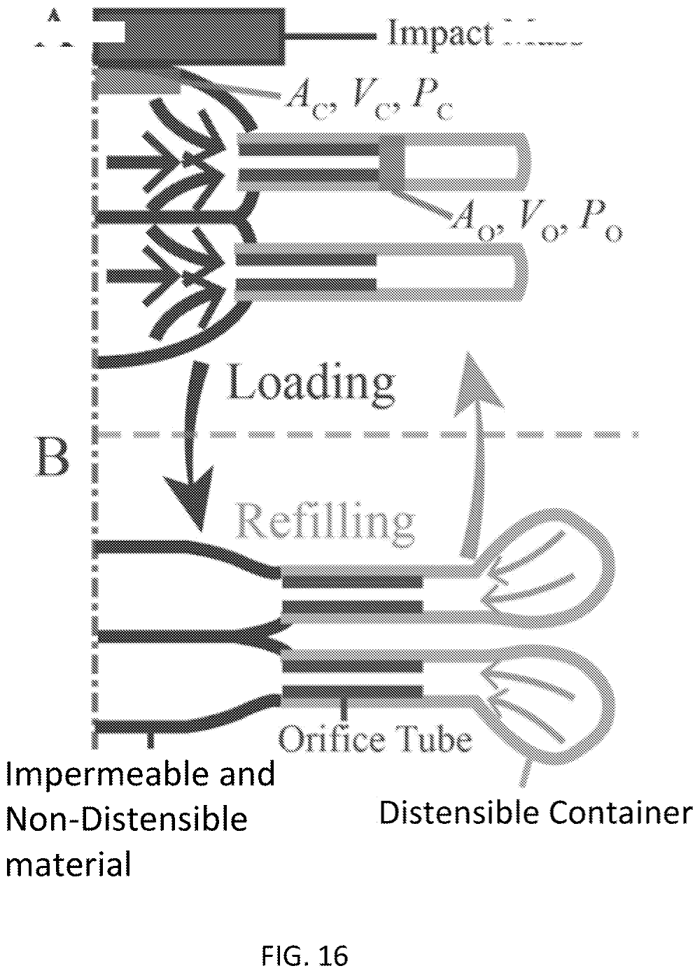

Turning to FIG. 16, an illustration of a cross-section of a serial stack of two shock bags undergoing an impact is shown. As an impact mass compresses the serial stack of two shock bags, fluid passes through orifices in the design into a distensible container. After impact the distensible container returns the fluid to the initial chamber.

FIG. 16 is an illustration of a cross-section of a serial stack of two shock bags undergoing an impact. As an impact mass compresses the serial stack of two shock bags, fluid passes through orifices in the design. Due to the small size of the orifices, the fluid velocity increases and the pressure decreases. According to Bernoulli's equation with ideal discharge and neglecting height difference in the shock absorber, the fluid at the contact area (area A_{C}, velocity V_{C} and pressure P_{C} in ideal discharge condition) and the fluid (density ρ) that has just passed through the orifices (area A_{O}, velocity V_{O} and pressure P_{O} in ideal discharge) are,

$${\underline{P}}_{C} + ρ \cdot \frac{{\underline{V}}_{C}^{2}}{2} = {\underline{P}}_{O} + ρ \cdot \frac{{\underline{V}}_{O}^{2}}{2} \qquad ( Eq . 1 )$$

According to the continuity equation and considering the embodiment in which there are two orifices in each shock of the serial stack of the shock bags,

$${\underline{V}}_{C} \cdot {A}_{C} = {\underline{V}}_{O} \cdot 2 {A}_{O} \qquad ( Eq \text{.2} )$$

Replacing Eq.2 into Eq.1,

$${\underline{P}}_{C} = {\underline{P}}_{O} + ( 1 - \frac{4 {A}_{O}^{2}}{{A}_{C}^{2}} ) \cdot ρ \cdot \frac{{\underline{V}}_{O}^{2}}{2} \qquad ( Eq \text{.3} )$$

Assuming that A_{O} is always small compared with A_{C}, we assume A_{O}²/A_{C}²<<1. Then, since the fluid is almost static when it goes into the distensible container, which stores the fluid passing through the orifice, P_{O} is mainly decided by elastic expansion of the distensible container and is negligible when compared to P_{C}. Therefore,

$${\underline{P}}_{C} = ρ \cdot \frac{{\underline{V}}_{O}^{2}}{2} \qquad ( Eq \text{.4} )$$

In actual discharge, because of the friction, heat transfer, and boundary layer thickness, the actual fluid velocity after the orifice is,

$${V}_{O} = {C}_{d} \cdot {\underline{V}}_{O} \qquad ( Eq \text{.5} )$$

Where C_{d} is the discharge coefficient. Replacing Eq.5 into Eq.4, the actual reaction force is,

$$F = {A}_{C} \cdot {P}_{C} = {A}_{C} \cdot ρ \cdot \frac{{V}_{O}^{2}}{2 {C}_{d}^{2}} = \frac{{A}_{C}^{3}}{4 {A}_{O}^{2}} \cdot ρ \cdot \frac{{V}_{C}^{2}}{2 {C}_{d}^{2}} \qquad ( Eq \text{.6} )$$

According to Eq.6, the serial liquid bag shock absorber is a non-linear damper where the reaction force depends on the contact area and the square of velocity.

In the ideal scenario, in order to reduce the damaging effects of an impact, a goal may be to reduce the peak force of such impact. To maximally reduce the peak force of a given impact loading, it is desirable to spread the impact energy evenly across the entire stroke of a shock absorber and the entire time duration of the impact event, such that a constant resulting impact force is achieved. In an example, in the context of blunt impacts to the helmeted human head, impact durations may last from 1 ms to 500 ms. The serial liquid bag shock absorber described herein acts to evenly spread the energy of such an impact over a longer time duration effecting a lower peak force.

By varying the number, size, and geometry of the orifices of the shock system, as well as the viscosity of the contained fluid, a wide range of force attenuation profiles may be achieved. For example, fluids ranging from 0.36 cP to 10,000 cP viscosity may be utilized, while orifice diameters of 0.25 mm to 75 mm may be utilized. Number of orifices may vary from one single orifice to several hundred orifices.

Further, in several embodiments, the one or more orifices may be embodied as holes in the material of the reservoir chamber or as additional parts affixed to the wall that create a defined opening through which fluid can flow. The size, geometry, surface qualities, and shape may affect the flow characteristics of the fluid passing through the orifice and its associated discharge coefficient. Therefore, these variables can be tuned to achieve desirable force profile characteristics for the system that are targeted towards a specific application.

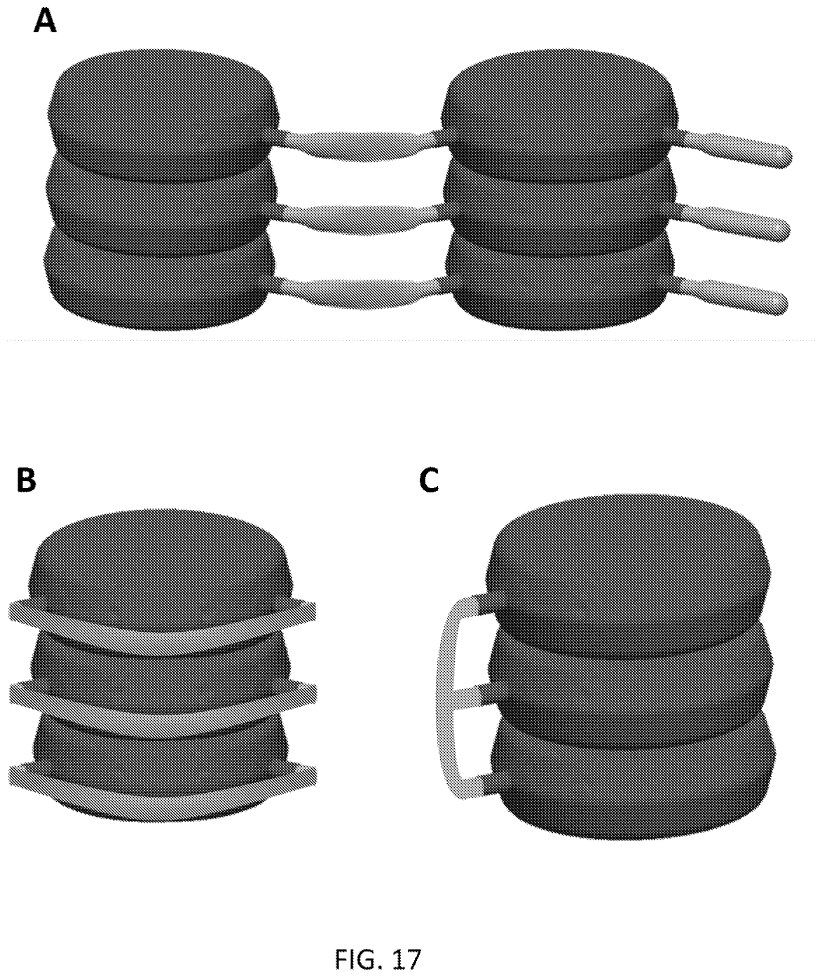

In several embodiments, it is possible that the distensible containers are connected to more than one of the orifices of a shock bag or multiple shock bags. Turning to FIGS. 17A-17C, two serial liquid shock bag absorbers are shown having orifices connecting to both shared distensible containers and unshared distensible containers. Each shock bag in the serial liquid shock bag absorber has two orifices that share a common distensible container. In another embodiment, more than two orifices may exist in a single shock bag and more than one shared distensible container may exist per shock bag. As shown in FIG. 17A, a set of two serial liquid shock bag absorbers can have their orifices connecting to shared distensible containers according to an example. As shown in FIG. 17B, shows an embodiment in which each shock bag of a serial liquid shock bag absorber includes two external orifices, where the two external orifices are connected to the same distensible container according to an example. As shown in FIG. 17C, the orifices from each shock bag of a serial liquid shock bag absorber connect to a shared distensible container.

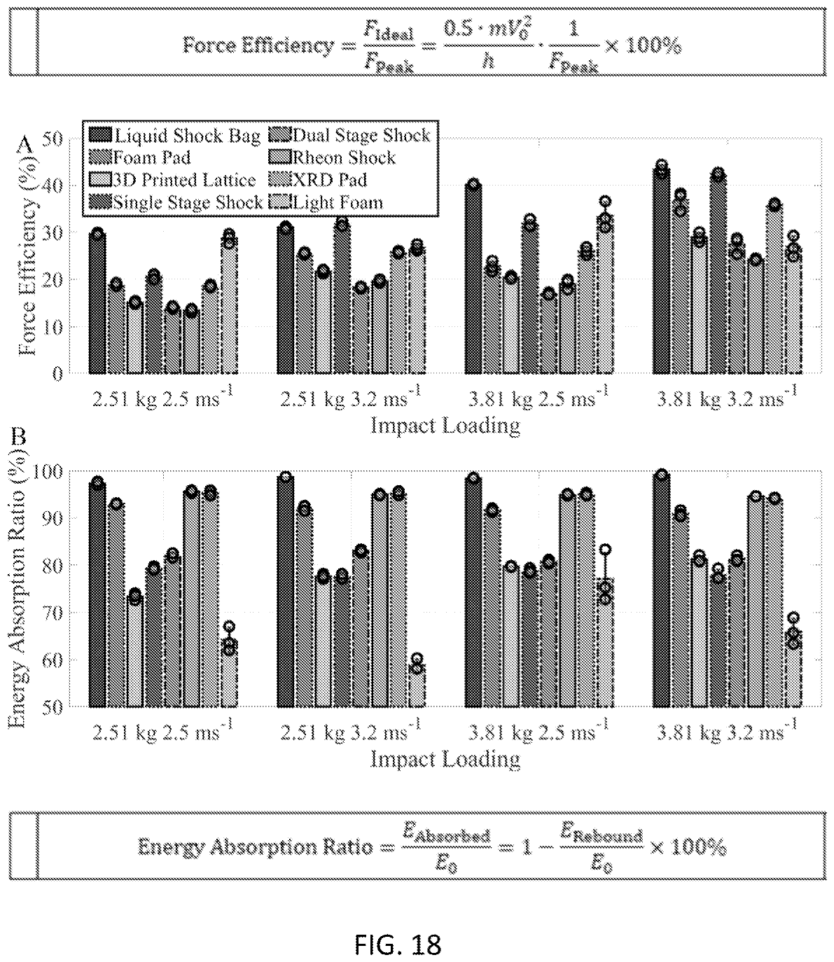

Turning to FIGS. 18A-18B, graphs are shown displaying force efficiency and energy absorption ratio results after impact testing of the serial liquid shock bag absorber and seven existing American football helmet shock absorbing technologies. Force efficiency describes the ability of a shock absorber to mitigate peak force within a certain shock absorber stroke and energy absorption ratio describes how much a shock absorber dissipates impact energy and suppresses rebounding of the impact mass.

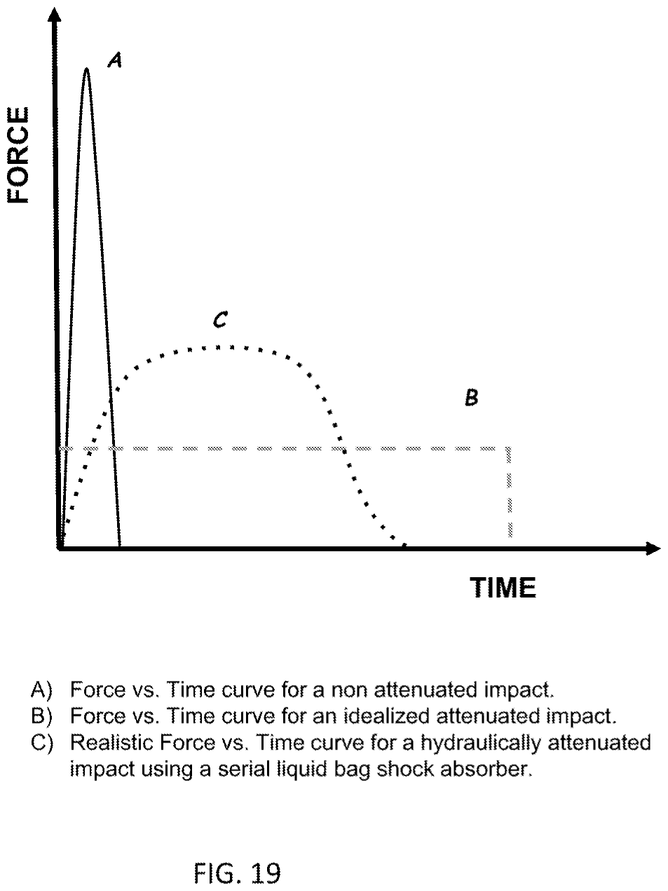

FIG. 19 displays examples of force vs. time curves of three impact scenarios. Curve A shows a force vs. time curve of an impact that is not attenuated. Curve B shows a force vs. time curve of an impact that is ideally attenuated such that it provides a constant force. Curve C shows a force vs. time curve of an impact that realistically approaches an ideally attenuated impact using hydraulic

While preferred embodiments of the present disclosure have been shown and described herein, it will be obvious to those skilled in the art that such embodiments are provided by way of example only. Numerous variations, changes, and substitutions will now occur to those skilled in the art without departing from the scope of the present disclosure. It should be understood that various alternatives to the embodiments described herein may be employed in practice. It is intended that the following claims define the scope of the disclosure and that methods and structures within the scope of these claims and their equivalents be covered thereby.

What is claimed is:

1. A shock absorbing device comprising:
a first collapsible chamber having a first reservoir space, a first wall configured to receive an impact force, and a first orifice configured to eject a fluid from the first reservoir space in reaction to the impact force; and
a second collapsible chamber having a second reservoir space, a second wall configured to receive at least a portion of the impact force, a second orifice in communication with the first orifice and the second reservoir space, and at least one ejection orifice in communication with the second reservoir space and configured to eject the fluid from the second reservoir space in reaction to said received portion of the impact force.

2. The device of claim 1, wherein at least one set of the first collapsible chamber and the second collapsible chamber are secured to an inner shell of a helmet.

3. The device of claim 2, wherein the at least one set of the first collapsible chamber and the second collapsible chamber are secured to a padding on the inner shell of the helmet.

4. The device of claim 1, wherein the first collapsible chamber and the second collapsible chamber are secured to a skullcap that is configured to be housed within an inner shell of a helmet.

5. The device of claim 1, further including at least one interfacing collapsible chamber between the first collapsible chamber and the second collapsible chamber.

6. The device of claim 1, wherein the first collapsible chamber and the second collapsible chamber are substantially non-distensible.

7. The device of claim 1, wherein the at least one ejection orifice further includes a sacrificial diaphragm that is configured to open at a predetermined pressure.

8. The device of claim 1, wherein the first collapsible chamber and second collapsible chamber are enclosed within a surrounding enclosure.

9. The device of claim 1, wherein the first orifice, second orifice, and at least one ejection orifice are variably sized and/or shaped to create an approximately constant reaction force to the impact force.

10. The device of claim 1, wherein at least one of the first collapsible chamber and the second collapsible chamber further includes a second ejection orifice that is configured to eject the fluid from at least one of the first reservoir space or second reservoir space in reaction to the impact force.

11. The device of claim 10, wherein the ejection orifice and second ejection orifice are oriented at an angle ranging from about 0 degrees to about 180 degrees relative to each other.

12. The device of claim 1, further comprising a distensible container attached to the at least one ejection orifice and configured to act as a reservoir to expand and contain fluid during application of the impact force and return the fluid back to recharge the reservoir spaces when the impact force is removed.

13. The device of claim 12, wherein the distensible container includes an elastic reservoir configured to maintain a constant back-pressure after an initial inflation.

14. The device of claim 1, wherein the fluid is incompressible.

15. The device of claim 1, wherein the second collapsible chamber comprises a plurality of ejection orifices.

16. The device of claim 1, wherein the first collapsible chamber comprises at least one other orifice besides the first orifice.

17. A shock absorbing device comprising:
a first collapsible chamber having a first reservoir space, a first wall configured to receive an impact force, and at least one first ejection orifice configured to eject a first incompressible fluid from the reservoir space in reaction to the impact force; and
a second collapsible chamber having a second reservoir space, a second wall configured to receive at least a portion of the impact force, and a second ejection orifice configured to eject a second incompressible fluid from the second reservoir space in reaction to said received portion of the impact force;
wherein the first collapsible chamber and the second collapsible chamber have an orientation such that said portion of the impact force received by the second wall of the second collapsible chamber is substantially parallel to a direction of the impact force received by the first wall of the first collapsible chamber.

18. The device of claim 17, further including at least one interfacing chamber between the first collapsible chamber and the second collapsible chamber, the interfacing collapsible chamber including a first interfacing wall configured to receive at least a portion of the impact force, and a third ejection orifice configured to eject a third incompressible fluid from the interfacing reservoir space in reaction to the at least a portion of the impact force.

19. The device of claim 17, further comprising at least one distensible container attached to the ejection orifice and configured to act as a reservoir to expand and contain fluid during application of the impact force and return the fluid back to recharge the reservoir spaces when the impact force is removed.

20. The device of claim 17, wherein each of the at least one first ejection orifice and the second ejection orifice include a sacrificial diaphragm that is configured to open at a predetermined pressure.

21. A shock absorbing device comprising:
a collapsible chamber having a reservoir space enclosed by a first impermeable layer configured to contain a fluid within the reservoir space, a second non-distensible layer surrounding the first layer and configured to receive an impact force, and at least one ejection orifice configured to eject a fluid from the reservoir space in reaction to the impact force.

22. The device of claim 21, wherein the at least one ejection orifice includes a sacrificial diaphragm that is configured to open at a predetermined pressure.

23. The device of claim 21, further comprising a distensible container attached to the at least one ejection orifice and configured to act as a reservoir to expand and contain fluid during application of the impact force and return the fluid back to recharge the reservoir spaces when the impact force is removed.
